(19) United States
(12) Patent Application Publication
(10) Pub. No.: US 2015/0162977 A1
(43) Pub. Date: Jun. 11, 2015

(54) METHOD AND APPARATUS FOR CONTROLLING SATELLITE COMMUNICATION NETWORK, AND METHOD OF COMMUNICATION BY VSAT CENTRAL STATION

(71) Applicant: ELECTRONICS AND TELECOMMUNICATIONS RESEARCH INSTITUTE, Daejeon (KR)

(72) Inventors: Mankyu PARK, Daejeon (KR); Hyun Ha HONG, Daejeon (KR); Deock Gil OH, Daejeon (KR)

(21) Appl. No.: 14/315,555

(22) Filed: Jun. 26, 2014

(30) Foreign Application Priority Data
Dec. 11, 2013 (KR) 10-2013-0153803

(51) Int. Cl. H04B 7/185; H04B 7/212

(52) U.S. Cl. CPC H04B 7/18528; H04B 7/2121; H04B 7/2125; H04L 12/4641

(57) ABSTRACT

A control method of a satellite communication network controller is provided. The satellite communication network controller registers terminals included in a plurality of satellite communication networks. The satellite communication network controller receives first data transmitted by a first terminal from a first central station included in a first satellite communication network. The satellite communication network controller searches from the terminals, a second terminal which is a destination of the first data. The satellite communication network controller determines a second central station to receive the first data by using registered information of the second terminal. The satellite communication network controller transmits the first data to the second central station. The second central station is included in the second satellite communication network.

### CROSS-REFERENCE TO RELATED APPLICATION

This application claims priority to and the benefit of Korean Patent Application No. 10-2013-0153803 filed in the Korean Intellectual Property Office on Dec. 11, 2013, the entire contents of which are incorporated herein by reference.

### BACKGROUND OF THE INVENTION

(a) Field of the Invention

The present invention relates to a method and apparatus for controlling a satellite communication network, and a communication method of a VSAT central station. More particularly, the present invention relates to a method and apparatus for controlling interworking between satellite communication networks.

(b) Description of the Related Art

As it is relatively easy to install a satellite communication network compared to a terrestrial network, the communication infrastructure of the satellite communication network can be built within a short time, and the satellite communication network has wider service coverage than the terrestrial network. Thanks to this advantage, satellite communication networks have been recently used as urgency communication networks in case of disasters and calamities, or have provided internet service to moving objects such as aircraft, ships, etc. that move over a long distance.

FIG. 1 is a view showing when satellite communication systems (or satellite communication networks) 10 and 20 having different time synchronization information.

The satellite communication system 10 is a system in which the synchronization start time is T0 and the duration of a time slot is ΔT0. The satellite communication system 10 includes a central station (or hub H1) and a plurality of terminals R1 to R3.

The satellite communication system 20 is a system in which the synchronization start time is T1 and the duration of a time slot is ΔT1. The satellite communication system 20 includes a central station (or hub H2) and a plurality of terminals R4 to R6.

The satellite communication system 10 enables communications C1 to C3 between the terminals R1 to R3 and the central station H1, and communication C4 between terminals (e.g., R1 and R3). The central station H1 transmits time synchronization information (e.g., T0 and ΔT0) to the terminals R1 to R3, and time synchronizes the terminals R1 to R3 with the entire system 10 by using the received time synchronization information. Thereafter, the terminals R1 to R3 transmit data by using time slots allocated by the central station H1.

The satellite communication system 20 enables communications C5 to C7 between the terminals R4 to R6 and the central station H2 and communication C8 between terminals (e.g., R5 and R6). The central station H2 transmits time synchronization information (e.g., T1 and ΔT1) to the terminals R4 to R6, and time synchronizes the terminals R4 to R6 with the entire system 20 by using the received time synchronization information. Thereafter, the terminals R4 to R6 transmit data by using time slots allocated by the central station H2.

However, if the two satellite communication systems 10 and 20 are not time-synchronized with each other, as shown in FIG. 3, the communication C9 between the terminal R3 and the terminal R6 is established.

### SUMMARY OF THE INVENTION

The present invention has been made in an effort to provide a method and apparatus having the advantage of enabling communication between terminals in satellite communication networks having different time information.

An exemplary embodiment of the present invention provides a control method of a satellite communication network controller. The control method includes: registering terminals included in each of a plurality of satellite communication networks; receiving first data transmitted by a first terminal of the terminals from a first central station included in a first satellite communication network of the plurality of satellite communication networks; searching from the terminals, a second terminal which is a destination of the first data; determining a second central station to receive the first data by using registered information of the second terminal; and transmitting the first data to the second central station. The second central station is included in a second satellite communication network of the plurality of satellite communication networks.

The registering may include classifying terminal information of the terminals according to the satellite communication networks.

The registering may further include: receiving terminal information of the first terminal that has logged on to the first central station from the first central station; and receiving terminal information of the second terminal that has logged on to the second central station from the second central station. The classifying may include: classifying the first terminal as corresponding to the first satellite communication network by using the terminal information of the first terminal; and classifying the second terminal as corresponding to the second satellite communication network by using the terminal information of the second terminal.

The terminal information of the first terminal may include information about the first central station, and the terminal information of the second terminal may include information about the second central station.

The satellite communication network controller may be connected to a backbone network.

The first satellite communication network and the second satellite communication network may not be time-synchronized with each other.

The transmitting of the first data may include transmitting the first data to the second central station by using a routing function.

The registering may further include registering the terminals by using an AAA (Authentication, Authorization, and Accounting) function.

The receiving of the first data may include receiving the first data via VLAN (Virtual LAN).

The transmitting of the first data may include transmitting the first data via VLAN (Virtual LAN).

The first terminal and the second terminal may be VSATs (Very Small Aperture Terminals).

Another embodiment of the present invention provides a satellite communication network controller. The satellite communication network controller includes a memory, and a processor that is connected to the memory and controls interworking between a first satellite communication network and a second communication network. The processor registers a first terminal included in the first satellite communication network and a second terminal included in the second satellite communication network, receives first data transmitted by the first terminal from a first central station included in the first satellite communication network, determines a second central station to receive the first data by using registered information of the second terminal which is a destination of the first data, and transmits the first data to the second central station. The second central station is included in the second satellite communication network.

Yet another embodiment of the present invention provides a method of communication by a VSAT central station included in a first satellite communication network. The method of communication by a VSAT central station includes: when a first VSAT terminal logs onto the VSAT central station, transmitting information of the first VSAT terminal to a satellite communication network controller; receiving first data from the first VSAT terminal; determining whether or not a second VSAT terminal, which is a destination of the first data, has logged onto the VSAT central station; and when the second VSAT terminal has not logged on to the VSAT central station, transmitting the first data to the satellite communication network controller.

### BRIEF DESCRIPTION OF THE DRAWINGS

FIG. 1 is a view showing when satellite communication systems having different time synchronization information.

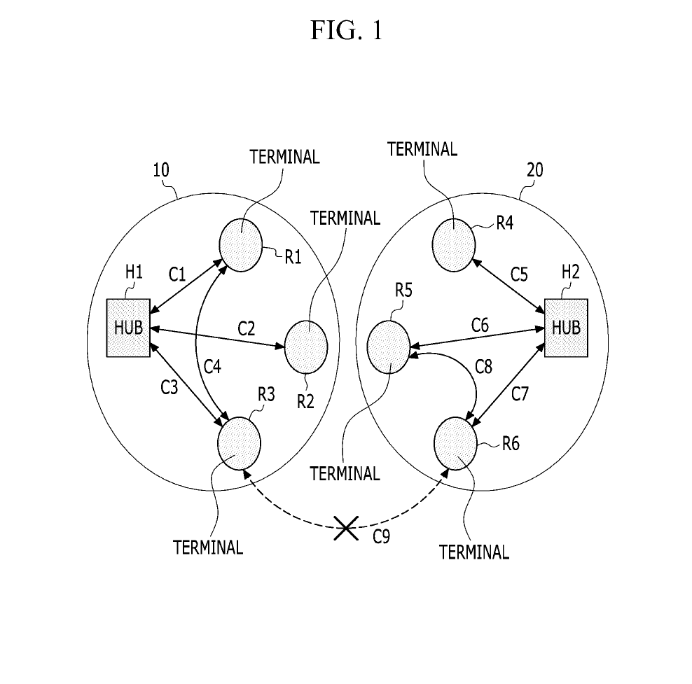

FIG. 2 is a view showing a communication method of a time-synchronized satellite communication system (or satellite communication network).

FIG. 3 is a view showing a TDMA access scheme.

FIG. 4 is a view showing a satellite communication network controller according to an exemplary embodiment of the present invention.

FIG. 5 is a view showing the connection relationship between the satellite communication network controller and the satellite communication systems according to an exemplary embodiment of the present invention.

FIG. 6 is a sequential chart showing a process for the satellite communication network controller to control interworking between the satellite communication systems according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

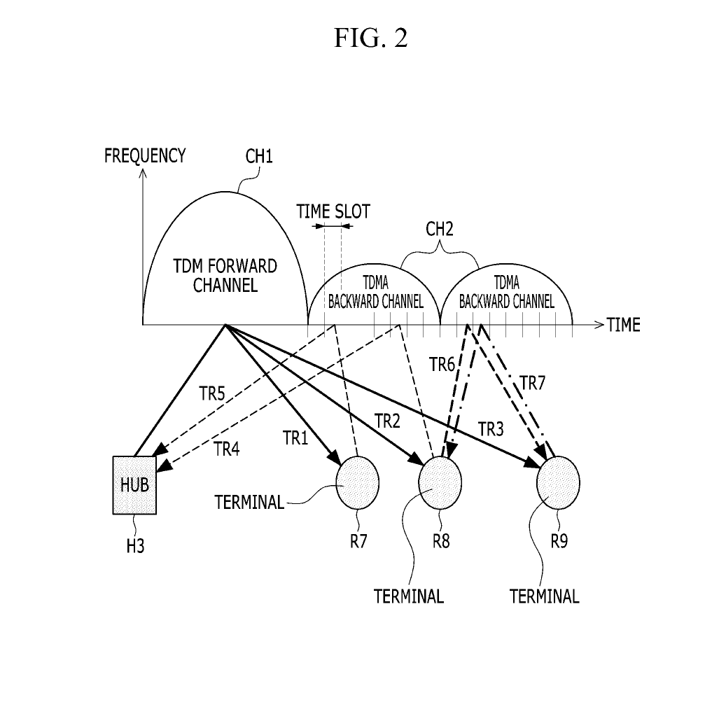

FIG. 2 is a view showing a communication method of a time-synchronized satellite communication system (or satellite communication network.

The satellite communication system may be a VSAT (Very Small Aperture Terminal) system. Also, the satellite communication system may be a DVB-RCS (Digital Video Broadcasting-Return Channel via Satellite)-based satellite communication system, well known as a VSAT system. The DVB-RCS-based satellite communication system is a closed-loop time synchronization system. In the DVB-RCS-based satellite communication system, a central station H3 transmits (TR1 to TR3) NCR (Network Clock Reference) information (e.g., time synchronization information) to terminals R7 to R9 via a forward channel CH1, and the terminals R7 to R9 are time-synchronized with the central station H according to the received NCR information. The central station H3 may be a hub. The central station H3 transmits (TR1 to TR3) TDM (Time Division Multiplexing) data (e.g., channel usage time information) to the terminals R7 to R9 via the forward channel CH1. The terminals R7 to R9 share satellite channel resources by using TDMA (Time Division Multiple Access). Specifically, the terminals R7 to R9 transmit data by using time slots allocated via a backward channel CH2. For example, the terminals R7 to R9 can transmit (TR4 and TR5) data to the central station H3 or transmit (TR6 and TR7) to terminals (e.g., R8 and R9). Moreover, communications (e.g., TR6 and TR7) between terminals in the satellite communication system can be implemented by SCPC (Single Channel Per Carrier) or TDMA mesh by using a mesh network formed among the terminals R7 to R9. Further, communications (e.g., TR4 and TR5) between the terminals R7 to R9 and the central station H3 in the satellite communication system can be implemented by using a star network.

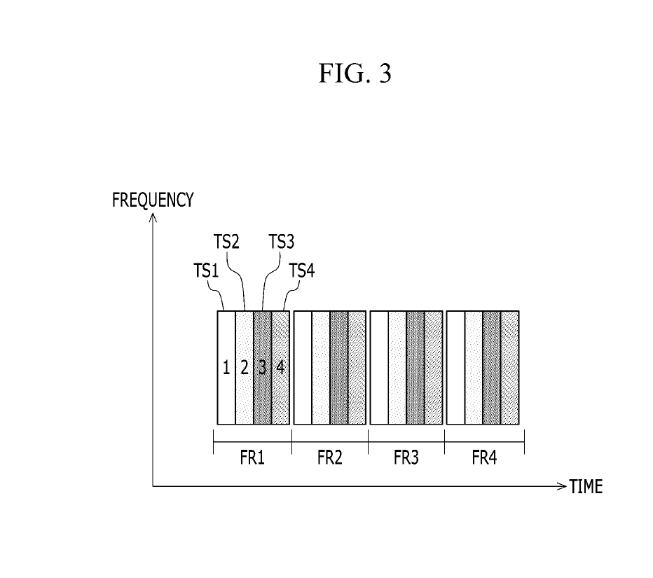

FIG. 3 is a view showing a TDMA access scheme.

When the terminals R7 to R9 transmit data to the central station H3 or other terminals R7 to R9, a TDMA access scheme is used. Specifically, the terminals R7 to R9 are assigned the right to use the time slots TS1 to TS4 (which are generated for one wireless transmission channel at constant time intervals) of each frame FR1 to FR4 from the central station H3, and transmit data by using the assigned time slots. That is, the TDMA access scheme is one in which a transmission channel (e.g., frequency resource) is shared in units of time slots when a plurality of terminals R7 to R9 transmit data.

Since the concept of the TDMA access scheme is to share a transmission channel, the central station H3 in a satellite communication system using the TDMA access scheme updates time slot allocation information at constant intervals and transmits it to the terminals R7 to R9. Accordingly, the satellite communication system using the TDMA access scheme is able to efficiently accommodate new terminals and properly perform data transmission, even for varying data traffic, by using a time slot allocation method (e.g., a method of continuously allocating time slots, a method of allocating time slots regularly at constant intervals, etc).

As the terminals R1 to R6 transmit data by the TDMA access scheme, the data cannot be decoded unless they know the correct TDMA-related parameters (e.g., superframe length, frame length, time slots, etc.). However, the terminals R1 to R3 in the satellite communication system (e.g., 10) do not know the correct TDMA-related parameters of the satellite communication system (e.g., 20) having different time information from the satellite communication system 10. Accordingly, the terminals R1 to R3 that are time-synchronized with the central station H1 of the satellite communication system 10 cannot communicate directly with the terminals R4 to R6 in the other satellite communication system 20.

A specific time slot is usually allocated to a specific terminal in a satellite communication system using the TDMA access scheme. Thus, the allocated time slot may be used as the name (or identifier) of this terminal. The address of the terminal may not be contained in the data. In this case, even if decoding is performed, it is not possible to determine which terminal has sent the data, and it is also not possible to respond to a request from the terminal that has sent the data.

A satellite communication network controller according to an exemplary embodiment of the present invention controls interworking between satellite communication systems (e.g., 10 and 20) which are not time-synchronized with each other, so as to allow the satellite communication systems 10 and 20 to communicate with each other. The satellite communication network controller may be installed in a backbone network outside the satellite communication systems 10 and 20.

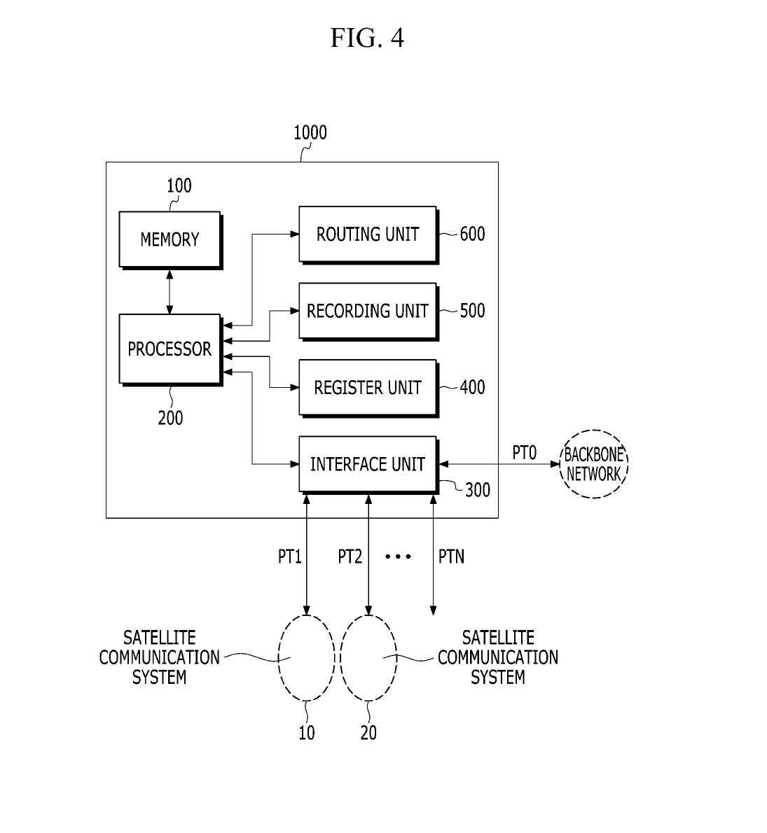

FIG. 4 is a view showing a satellite communication network controller 1000 according to an exemplary embodiment of the present invention.

The satellite communication network controller 1000 includes a memory 100, a processor 200, an interface unit 300, a register unit 400, a recording unit 500, and a routing unit 600.

The memory 100 is connected to the processor 200, and stores various pieces of information related to operations of the processor 100.

The processor 200 controls interworking between satellite communication systems (e.g., 10 and 20). The processor 200 controls the interface unit 300, the register unit 400, the recording unit 500, and the routing unit 600.

The interface unit 300 provides a connection between the satellite communication systems 10 and 20. Specifically, the interface unit 300 may include a plurality of physical access ports to establish a wired connection with a plurality of satellite communication systems 10 and 20. Also, the interface unit 300 may be connected to the satellite communication systems 10 and 20 via security connecting paths PT1 to PTN having a security function. The security connecting paths PT1 to PTN may be VLANs (Virtual LANs). FIG. 4 illustrates the interface unit 300 being connected to the satellite communication systems 10 and 20 via the security connecting paths PT1 and PT2 for convenience of explanation. However, this is only an illustration, and the interface unit 300 supports a connection with two or more satellite communication systems. The interface unit 300 may further include a physical access port for establishing a connection with the backbone network, and may be connected to the backbone network via a connecting path PT0.

The register unit 400 registers the terminals R1 to R6 included in the satellite communication systems 10 and 20. Specifically, the register unit 400 may register the terminals R1 to R6 by performing an AAA (Authentication, Authorization, and Accounting) function. The register unit 400 manages terminal information of the terminals R1 to R6 in a hierarchical way. That is, the register unit 400 classifies and manages this information according to the satellite communication systems 10 and 20 or according to the central stations H1 and H2. The terminal information of the terminals R1 to R6 includes information about the terminals R1 to R6 and information about the central stations H1 and H2 that manage the terminals R1 and R2. For example, the register unit 400 manages this information by classifying the terminal information of the terminals R1 to R3 as corresponding to the satellite communication system 10 and the terminal information of the terminals R4 to R6 as corresponding to the satellite communication system 20. Also, the register unit 400 can manage the terminals R1 to R6 by using an M-bit register identifier. Part of the M-bit register identifier may be a bit for a central station, and the remaining parts may be bits for terminals. For example, the foremost bit of the 3-bit register identifier is a bit for a central station. If this bit is ‘0’, it may indicate the central station H1, and if this bit is ‘1’, it may indicate the central station H2. The subsequent 2 bits are bits for terminals. If these bits are ‘00’, they may indicate the terminals R1 and R4, if these bits are ‘01’, they may indicate the terminals R2 and R5, and if these bits are ‘10’, they may indicate the terminals R3 and R6. For example, the register identifier ‘000’ indicates the terminal R1.

The routing unit 600 performs a routing function to determine the transmission path of received data. Specifically, the routing unit 600 searches for the destination of received data in the registered terminals R1 to R6, and determines the central station H1 or H2 to which the received data will be transmitted, by using the terminal information of the searched terminal. Next, the routing unit 600 transmits the received data to the determined central station H1 or H2 via the security connecting paths PT1 to PTN. For example, if the destination of the received data is the terminal R4, the routing unit 600 acquires information about the central station H2 that manages the terminal R4, based on the terminal information of the terminal R4, and transmits the received data to the central station H2 via the security connecting path PT2, based on the acquired information about the central station H2.

The recording unit 500 records a history of use of the satellite communication network controller 1000 when interworking between the satellite communication systems 10 and 20 is provided or connection to the backbone network is provided.

Specifically, if the satellite communication network controller 1000 transmits the data transmitted from the satellite communication system 10 to the satellite communication system 20, the recording unit 500 records this transmission.

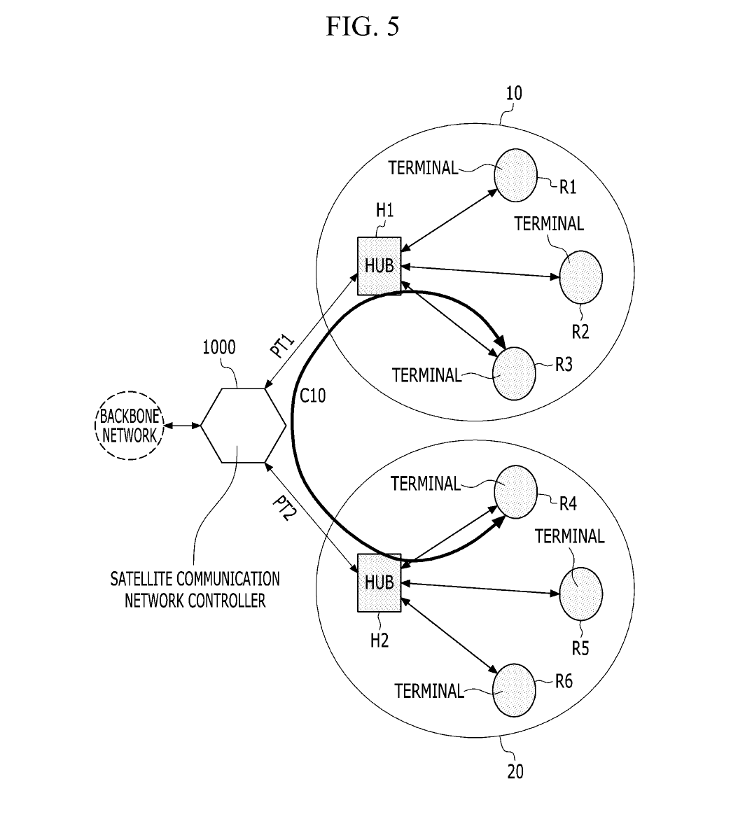

FIG. 5 is a view showing the connection relationship between the satellite communication network controller 1000 and the satellite communication systems 10 and 20 according to an exemplary embodiment of the present invention. The terminals R1 to R6 may be VSAT terminals, and the central stations H1 and H2 may be VSAT central stations. The satellite communication network controller 1000 may be located outside the satellite communication systems 10 and 20 (e.g., in a backbone network). FIG. 5 assumes that the satellite communication network controller 1000 is connected to the satellite communication system 10 via the security connecting path PT1 and connected to the satellite communication system 20 via the security connecting path PT2. FIG. 5 also assumes that the satellite communication systems 10 and 20 have different time information, that is, are not time-synchronized with each other. Referring to FIG. 5, a control process of the satellite communication network controller 1000 will be described.

When the terminals R1 to R3 log on to the central station H1 and the terminals R4 to R6 log on to the central station H2, the central stations H1 and H2 transmit the terminal information of the terminals R1 to R6 to the satellite communication network controller 1000 via the security connecting paths PT1 and PT2.

The satellite communication network controller 1000 manages the received terminal information of the terminals R1 to R6 according to the satellite communication systems 10 and 20. That is, the satellite communication network controller 1000 manages this information by classifying the terminals R1 to R3 as the terminals of the central station H1 and the terminals R4 to R6 as the terminals of the central station H2. The terminal information of the terminals R1 to R6 is firstly managed by the central stations H1 and H2 of the satellite communication systems 10 and 20, and secondly managed by the satellite communication network controller 1000.

If the terminal R3 of the satellite communication system 10 sends data to the terminal R4 of the satellite communication system 20, the central station H1 determines whether the terminal R4, that is, the destination of the data, is the terminals R1 to R3 managed by the central station H1. If the terminal R4 is not the terminals R1 to R3 managed by the central station H1, the central station H1 transmits the received data to the satellite communication network controller via the security connecting path PT1.

The satellite communication network controller 1000 determines the path over which the data received from the central station H1 will be transmitted, by using the routing function. The satellite communication network controller 1000 acquires information about the central station H2 that manages the terminal R4, that is, the destination of received data, and routes the received data to the central station H2 based on the acquired information about the central station H2.

The central station H2 receives data from the satellite communication network controller 1000 via the security connecting path PT2, and transmits the received data to the terminal R4, that is, the destination.

By doing so, the terminal R3 of the satellite communication system 10 is able to communicate (010) with the terminal R4 of the satellite communication system 20, which is not time-synchronized with the satellite communication system 10.

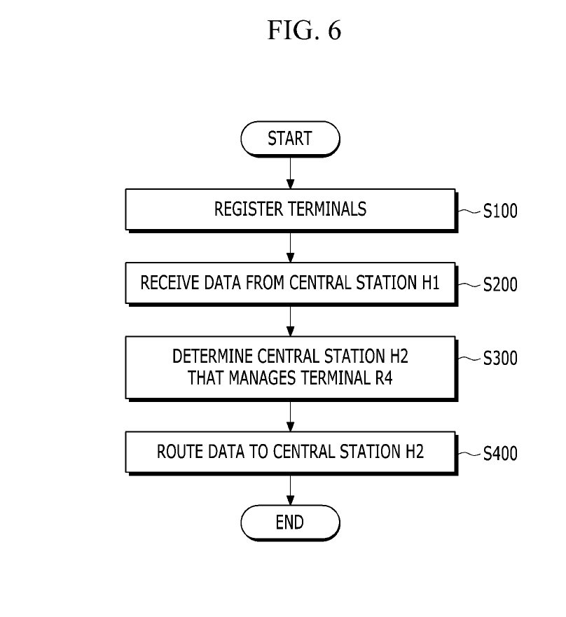

FIG. 6 is a sequential chart showing a process for the satellite communication network controller 1000 to control interworking between the satellite communication systems 10 and 20 according to an exemplary embodiment of the present invention. Referring to FIG. 6, control operations of the satellite communication network controller 1000 will be briefly described.

The satellite communication network controller 1000 registers the terminals R1 to R6 that have logged on to the central stations H1 and H2 (S100). Upon receiving, from the central station H1, data transmitted by the terminal R3, the satellite communication network controller 1000 determines the central station H2 that manages the terminal R4, which is the destination of the received data (S300).

The satellite communication network controller 1000 routes the received data to the central station H2 determined during S300 (S400).

According to an embodiment of the present invention, a satellite communication network controller enables communication between VSAT terminals included in different satellite communication networks by controlling interworking between the satellite communication networks. That is, an external satellite communication network controller enables communication between VSAT terminals included in different satellite communication networks even if the satellite communication networks are not time-synchronized with each other. Accordingly, small-scale satellite communication networks can be managed in an integrated manner, and the range of communication services can be easily broadened.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A control method of a satellite communication network controller, the method comprising:
registering terminals included in each of a plurality of satellite communication networks;
receiving first data transmitted by a first terminal of the terminals from a first central station included in a first satellite communication network of the plurality of satellite communication networks;
searching from the terminals, a second terminal which is a destination of the first data;
determining a second central station to receive the first data by using registered information of the second terminal; and
transmitting the first data to the second central station,
wherein the second central station is included in a second satellite communication network of the plurality of satellite communication networks.

2. The method of claim 1, wherein the registering comprises classifying terminal information of the terminals according to the satellite communication networks.

3. The method of claim 2, wherein
the registering further comprises:
receiving terminal information of the first terminal that has logged on to the first central station from the first central station; and
receiving terminal information of the second terminal that has logged on to the second central station from the second central station, and
the classifying comprises:
classifying the first terminal as corresponding to the first satellite communication network by using the terminal information of the first terminal; and
classifying the second terminal as corresponding to the second satellite communication network by using the terminal information of the second terminal.

4. The method of claim 3, wherein
the terminal information of the first terminal comprises information about the first central station, and
the terminal information of the second terminal comprises information about the second central station.

5. The method of claim 4, wherein the satellite communication network controller is connected to a backbone network.

6. The method of claim 4, wherein the first satellite communication network and the second satellite communication network are not time-synchronized with each other.

7. The method of claim 6, wherein the transmitting of the first data comprises transmitting the first data to the second central station by using a routing function.

8. The method of claim 7, wherein the registering further comprises registering the terminals by using an AAA (Authentication, Authorization, and Accounting) function.

9. The method of claim 1, wherein the receiving of the first data comprises receiving the first data via VLAN (Virtual LAN).

10. The method of claim 1, wherein the transmitting of the first data comprises transmitting the first data via VLAN (Virtual LAN).

11. The method of claim 1, wherein the first terminal and the second terminal are VSATs (Very Small Aperture Terminals).

12. A satellite communication network controller comprising:
a memory; and
a processor that is connected to the memory and controls interworking between a first satellite communication network and a second communication network,
wherein the processor registers a first terminal included in the first satellite communication network and a second terminal included in the second satellite communication network, receives first data transmitted by the first terminal from a first central station included in the first satellite communication network, determines a second central station to receive the first data by using registered information of the second terminal which is a destination of the first data, and transmits the first data to the second central station,
the second central station being included in the second satellite communication network.

13. The satellite communication network controller of claim 12, wherein the processor controls an interface unit for connecting the first satellite communication network, the second satellite communication network, and a backbone network.

14. The satellite communication network controller of claim 13, wherein the processor controls a register unit that classifies the first terminal and the second terminal according to the first and second satellite communication networks, and registers the first and second terminals by using an AAA function.

15. The satellite communication network controller of claim 14, wherein the processor controls a routing unit that determines the second central station to receive the first data by using registered information of the second terminal,
the registered information of the second terminal comprising information about the second central station to which the second terminal has logged on.

16. The satellite communication network controller of claim 15, wherein the processor controls a recording unit that records transmission of the first data to the second central station when this transmission occurs.

17. The satellite communication network controller of claim 16, wherein the first data is transmitted to the second central station via connecting paths having a security function.

18. The satellite communication network controller of claim 17, wherein the first terminal and the second terminal are VSATs (Very Small Aperture Terminals).

19. The satellite communication network controller of claim 18, wherein the first satellite communication network and the second satellite communication network are not time-synchronized with each other.

20. A method of communication by a VSAT central station included in a first satellite communication network, the method comprising:
when a first VSAT terminal logs onto the VSAT central station, transmitting information of the first VSAT terminal to a satellite communication network controller;
receiving first data from the first VSAT terminal;
determining whether or not a second VSAT terminal, which is a destination of the first data, has logged onto the VSAT central station; and
when the second VSAT terminal has not logged on to the VSAT central station, transmitting the first data to the satellite communication network controller.
